(19) United States
(12) Patent Application Publication
(10) Pub. No.: US 2011/0186017 A1
(43) Pub. Date: Aug. 4, 2011

(54) Single-crankshaft, opposed-piston engine constructions

(75) Inventors: James U. Lemke, La Jolla, CA (US); Patrick R. Lee, San Diego, CA (US); William B. McHargue, Encinitas, CA (US); Bryant A. Wagner, San Diego, CA (US)

(73) Assignee: Achates Power, Inc., San Diego, CA (US)

(21) Appl. No.: 12/931,485

(22) Filed: Feb. 2, 2011

Related U.S. Application Data
(60) Provisional application No. 61/337,370, filed on Feb. 3, 2010.
(60) Provisional application No. 61/337,372, filed on Feb. 3, 2010.

(51) Int. Cl. F02B 75/28; F02B 75/32

(52) U.S. Cl. 123/51 R; 123/197.4

(57) ABSTRACT

Ported engines with opposed pistons are coupled to a single crankshaft through rocker arm linkages. Each pair of opposed pistons is coupled to a single crankpin of the crankshaft. Each piston is coupled to a respective rocker arm linkage by a rolling thrust bearing which prevents linkage movement that is transverse to the axis of the piston from being transferred to the piston. Each piston of a pair of opposed pistons is coupled to the same crankpin by respective rocker arm linkages in which connecting rods run between the crankpin and respective rocker arms. One connecting rod is connected to first rocker arm below the rocker arm's pivot point and another connecting rod is connected to a second rocker arm above the rocker arm's pivot point.

### PRIORITY

This application claims benefit of US provisional application for patent 61/337,370, filed Feb. 3, 2010 and to US provisional application for patent 61/337,372, filed Feb. 3, 2010.

### BACKGROUND

The field of the invention includes ported internal combustion engines with opposed pistons coupled to a single crankshaft through linkages in which connecting rods for opposed-pistons are asymmetrically disposed. Each pair of opposed pistons is coupled to a single crankpin of the crankshaft. Each piston is coupled to a respective connecting rod linkage by a rolling thrust bearing which transmits linkage motion that is parallel to the axis of the piston. Each piston of a pair of opposed pistons is coupled to the same crankpin of a crankshaft by respective rocker arm assemblies in which: connecting rods run between the crankpin and respective rocker arms, one connecting rod is connected to a first rocker arm below the rocker arm's pivot point, and another connecting is connected to a second rocker arm above the rocker arm's pivot point.

A ported internal combustion engine is an internal combustion engine having a cylinder with one or more ports through its side wall for the passage of gasses into and/or out of the bore of the cylinder. Relatedly, such a cylinder is a ported cylinder. For example, an opposed-piston engine typically includes exhaust and intake ports cast, machined, or otherwise formed in the cylinder sidewall near respective exhaust and intake ends thereof. A ported cylinder can be constituted as a unitary structure, as an element of an engine structure, or as a liner (sometimes called a “sleeve”) received in an engine block or spar to form a cylinder.

Ported, opposed-piston diesel engines have an acknowledged potential for superior performance according to standard measures of output power and fuel efficiency. For example, the Rootes-Lister diesel engine (also known as the Commer ‘TS3’ diesel) illustrated in FIG. 1 advanced ported two-stroke engine construction by way of an engine configuration that included three pairs of opposed pistons driving a single crankshaft. Each piston was coupled to a respective crankpin by a rocker assembly. Each rocker assembly included a rocker arm pivoted between two ends, a piston rod connected to a first end of the rocker arm and to a wrist pin located inside the piston, and a connecting rod connecting the second end of the rocker arm to a crankpin. All of the rocker assemblies were identical, with each rocker arm end being pivoted to the engine frame. The crankshaft had complementary crankpins that were about 180° apart to effect simultaneous motion of their respective pistons inwardly and outwardly. The symmetry of motion precluded the desirable port phasing of early opening of the exhaust port and simultaneous closing of the exhaust and inlet ports. The architecture of the rocker assemblies significantly reduced side forces acting on the pistons, thereby making the engine very durable. However, at least two construction features severely compromised the performance of the Rootes-Lister engine.

First, the provision of two crankpins per cylinder resulted in an offset connection between the crankshaft pin centerline and the centerline of the piston thereby limiting the peak combustion pressure that could be accommodated without adverse bearing stresses. Second, in the Rootes-Lister engine wrist pins (“gudgeon” pins, UK) were mounted inside the pistons, which limited the size of the bearings for the pins, and therefore the ultimate load bearing capacity of the pistons. As a result of these constraints, the engine was limited to operating at very low power levels (about 38 HP/liter). Also, location of the wrist pin within the piston skirt restricted passage of coolant to the crown of the piston.

Examples of opposed-piston engine constructions that remove wrist pins from inside pistons are found in Great Britain Patent 558,115 and in U.S. Pat. Nos. 7,156,056 B2 and 7,360,551 B2. In each case, there is no articulation of the piston-to-crankshaft linkage that is internal to the piston. Instead, joints external to the pistons couple the linear motions of the pistons to each of a pair of crankshafts located above and below the cylinders. The axes of the crankshafts lie in a plane that is normal to the axes of, and that bisects, the cylinders. Both crankshafts are connected to each pair of opposed pistons through multiple connecting rods. This configuration results in engines that require very long, crankshaft constructions with many crankpins to accommodate multiple connecting rods. The length and number of the crankshafts, and the proliferation of connecting rods, add weight to these engines. Further, because both crankshafts are coupled to each pair of pistons, very close tolerances must be maintained during manufacturing to avoid, or at least mitigate, misalignment between the connecting rods and external wrist pins that could result in undesirable side forces exerted on the pistons. A consequence of coupling both crankshafts to the single wrist pin of each piston is an over-constraint condition whereby unequal elastic deformation of the coupling components can lead to significant deflection of the wrist pin in a direction that produces undesirable side forces acting on the piston.

Accordingly, the potentially high power levels in ported, two-stroke, opposed-piston engines have not been fully achieved by single crankshaft constructions with rocker assemblies because wrist pins are located inside the pistons. However, dual-crankshaft constructions in which the wrist pins have been removed from, and relocated outside of, the pistons have also not achieved full power potential due to side forces resulting from over constraint of the wrist pins.

### SUMMARY

An object of this invention is therefore to provide an opposed-piston engine construction capable of operating at high power levels.

Another object is to eliminate forces orthogonal to piston motion that are produced by over-constraint of multiple crankshafts with common connections to the pistons of an opposed-piston engine.

Another object is to reduce the weight of an opposed-piston engine.

In general, these and other objects are achieved in an opposed-piston engine construction in which pistons are connected to connecting linkages with thrust bearings which do not limit the load bearing capacity of the pistons resulting from bearing size constraints.

In general, these and other objects are achieved in an opposed-piston engine construction in which each piston is connected to a connecting linkage by a thrust bearing which transmits connecting linkage movement that is parallel to the piston's motion, thereby preventing undesirable side forces from acting on the piston.

In general, these and other objects are achieved in an opposed-piston engine construction with a single crankshaft in which each pair of opposed pistons is connected to a single crankpin on the crankshaft.

In general, these and other objects are achieved in an opposed-piston engine construction which includes a single crankshaft, one or more cylinders with exhaust and intake ports, and a pair of opposed pistons disposed in each cylinder. Each piston of a pair of opposed pistons is linked by a respective rocker arm assembly and connecting pin to the same crankpin on a crankshaft. Each rocker arm assembly is pivotally attached to a thrust bearing constituted of a pair of bearing plates having complementarily curved, linearly-grooved faces disposed in opposition and a curved rolling ball assembly between the curved faces to support relative movement between the plates. The thrust bearing is secured to a piston by way of the open end of the piston skirt.

In general, these and other objects are further achieved in an opposed-piston engine with a single crankshaft in which the length and weight of the crankshaft are reduced by coupling each pair of opposed pistons to a single crankpin of the crankshaft. In this regard, the pistons are disposed in opposition through respective ends of a cylinder with exhaust and intake ports. Each piston is connected to the crankpin by a respective rocker arm assembly. Each rocker arm assembly includes a rocker arm and a connecting rod. Each rocker arm is disposed normal to a plane containing the longitudinal axes of the cylinders and is pivoted to an engine frame at a pivot point between its upper and lower ends. The piston which controls the exhaust port is coupled by a thrust bearing to the upper end of a rocker arm. One end of the connecting rod is coupled to the crankpin and the other end is coupled to the lower end of the rocker arm. The piston which controls the intake port is coupled by a thrust bearing to the upper end of a rocker arm. One end of the connecting rod is coupled to the crankpin and the other end to the rocker arm between the pivot point and upper end of the rocker arm. The asymmetrical coupling introduces a nonlinear phase difference in the motions of the pistons that establishes port phasing.

### BRIEF DESCRIPTION OF THE DRAWINGS

The below-described drawings are meant to illustrate principles and examples discussed in the following detailed description of embodiments without limiting the invention. They are not necessarily to scale.

FIG. 1. is a partially schematic sectional view of a prior art opposed-piston engine, and is appropriately labeled “Prior Art”.

FIG. 2 is a perspective view of a partially-assembled opposed-piston engine.

FIG. 3 shows the engine of FIG. 2 with a frame removed to show a preferred connecting rod configuration.

FIG. 4 is a view of the engine of FIG. 2 from beneath the engine.

FIGS. 5A and 5B show the single crankshaft of the engine of FIG. 2 from two different aspects.

FIGS. 5C and 5D show respective connecting rod embodiments of the engine of FIG. 2.

FIG. 6 is a perspective view of the engine of FIG. 2 with an alternate connecting rod configuration.

FIG. 7 shows the engine of FIG. 6 with the frame removed to show the alternate connecting rod configuration.

FIG. 8 is a view of the engine of FIG. 7 from beneath the engine.

FIGS. 9A and 9B show alternate connecting rod embodiments of the engine of FIG. 6.

FIG. 10 is a side view of a thrust bearing assembly installed in a piston and attached to the upper end of a rocker arm.

FIG. 11A is a cross sectional view of a piston with a rolling thrust bearing mounted therein which illustrates how the thrust bearing operates as a virtual wrist pin.

FIG. 11B is a cross sectional view of the piston of FIG. 11A showing the rolling thrust bearing when the piston is at TDC (top dead center) and BDC (bottom dead center) positions.

FIG. 11C is a cross sectional view of the piston of FIG. 11A showing the thrust bearing when the piston is at 90° and 270° positions.

FIGS. 12A through 12F depict assembly of the thrust bearing.

FIG. 13 is a graph representing port phasing with respect to a 180° crank throw angle in the engine of FIGS. 2-4.

FIG. 14 is an enlarged plan view of the curved, linearly-grooved face of a flexible bearing plate.

FIG. 15A is a side sectional view of the engine of FIGS. 2-4 showing additional details of the engine's construction; FIG. 15B is an enlarged vie of a portion of the engine of FIG. 15A.

### DETAILED DESCRIPTION OF THE PREFERRED EMBODIMENTS

The opposed-piston engine constructions illustrated and described herein all incorporate a single crankshaft and connecting linkages which couple a pair of opposed pistons to a single crankpin of the crankshaft. Each piston is coupled to a connecting linkage by a thrust bearing with a large effective diameter that replaces the normal wrist pin connection, thereby not limiting the size of the bearings needed to absorb the movement of the piston. Asymmetrical coupling of connecting rods in the connecting linkages establish port phasing.

This specification and the accompanying drawings are directed to constructions for an opposed-piston, internal-combustion, compression-ignition engine with a single crankshaft having an axis of rotation located in a plane perpendicular to a plane containing the longitudinal axes of the cylinders. Although embodiments with two cylinders are disclosed, these are not intended to limit the application of the invention just to two cylinder constructions. In fact, the invention can also be practiced in opposed-piston engine constructions with one cylinder, two cylinders, three cylinders, and four or more cylinders.

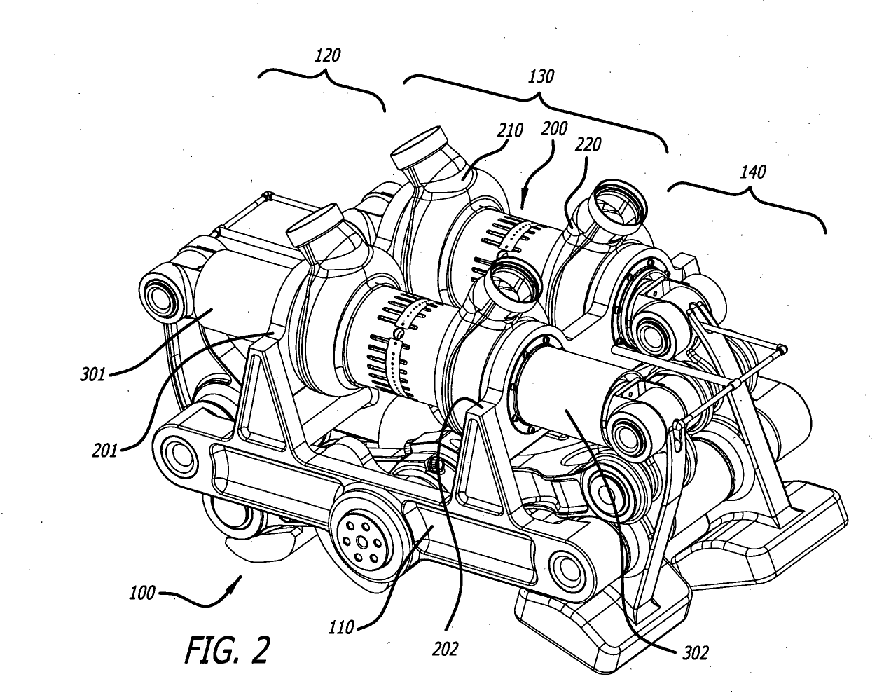

FIG. 2 shows an opposed-piston engine construction embodied in a two-cylinder engine 100 with an outside shell removed to identify the various elements of the engine. The shell can be a three-piece assembly wherein one portion would cover an exhaust end of the engine 120 up to an exhaust manifold 210. A second section of the shell would cover an intake end of the engine 140 up to an intake manifold 220. A third portion of the shell would completely cover a central cylinder section 130 including exhaust 210 and intake 220 manifolds With this shell configuration, the manifolds 210 and 220 would be isolated from fluids (such as coolants and/or lubricants) splashing in the engine spaces. One advantage of this shell design is that the manifolds, especially the exhaust manifold 210, are isolated from these fluids and coking of these fluid on the manifolds is thereby avoided.

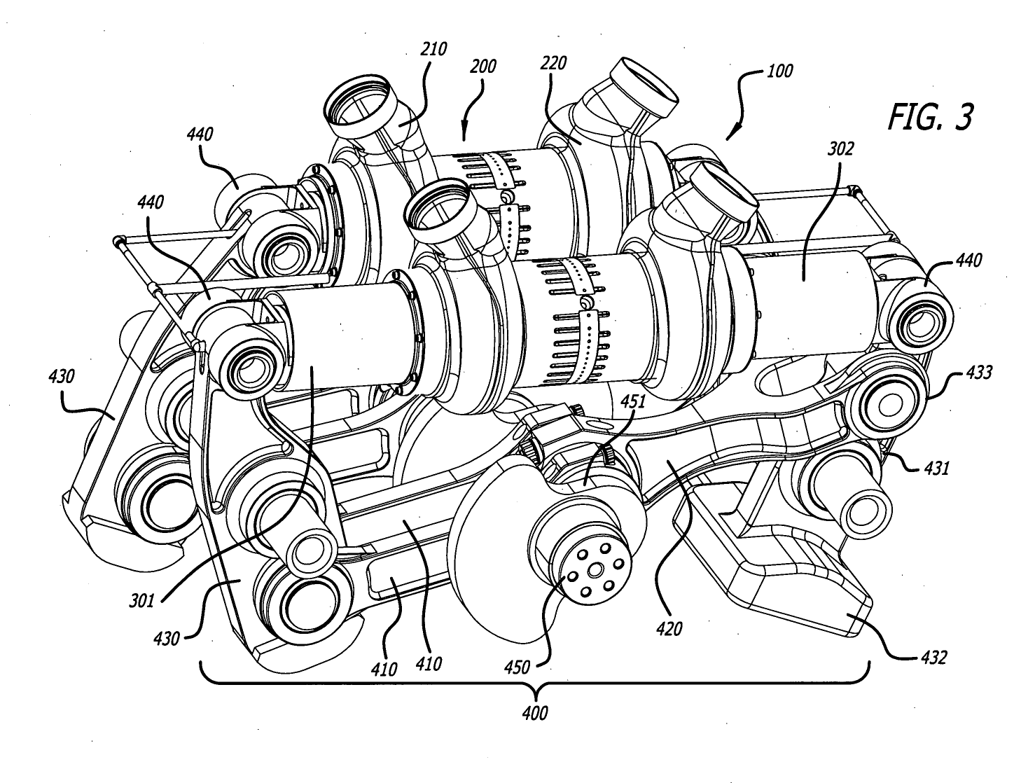

As per FIG. 2, a frame 110 supports two cylinders 200. Each cylinder 200 has exhaust and intake ports formed in respective ends 201 and 202, and a bore with a pair, of opposed pistons disposed therein. The piston 301 disposed in the exhaust end 201 controls the exhaust port of the cylinder and the piston 302 disposed in the intake end 202 controls the intake port. As seen in FIG. 3, the frame also supports a drive train assembly 400. Referring now to FIGS. 2 thru 5A and 5B, the drive train assembly 400 includes a single crankshaft 450 with a single crankpin 451 per cylinder. That is to say, each of the two crankpins 451 is coupled to a respective pair of opposed pistons.

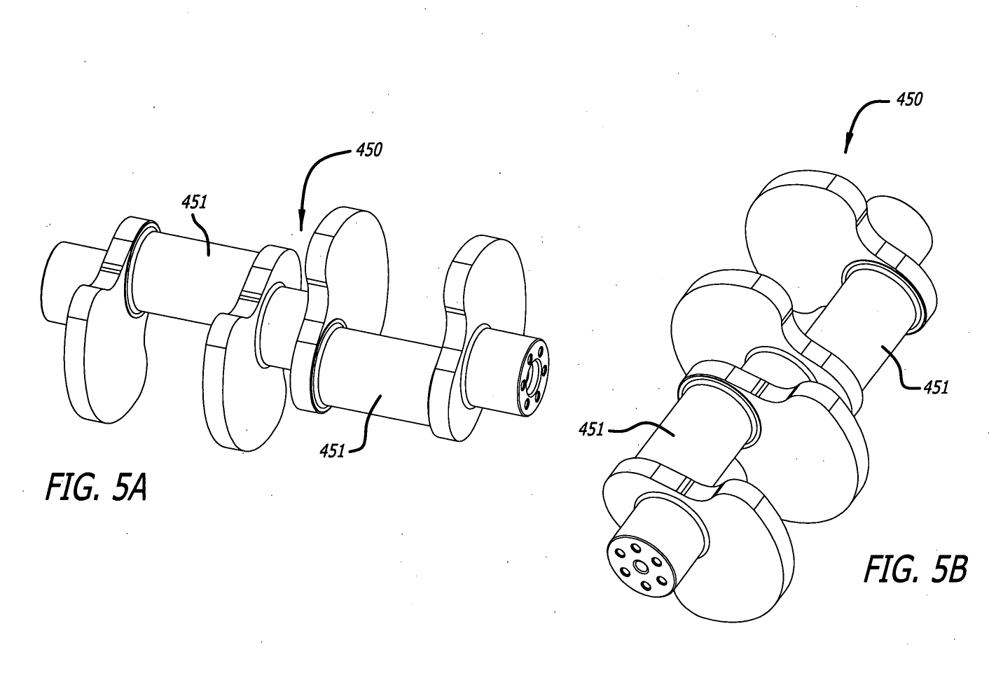

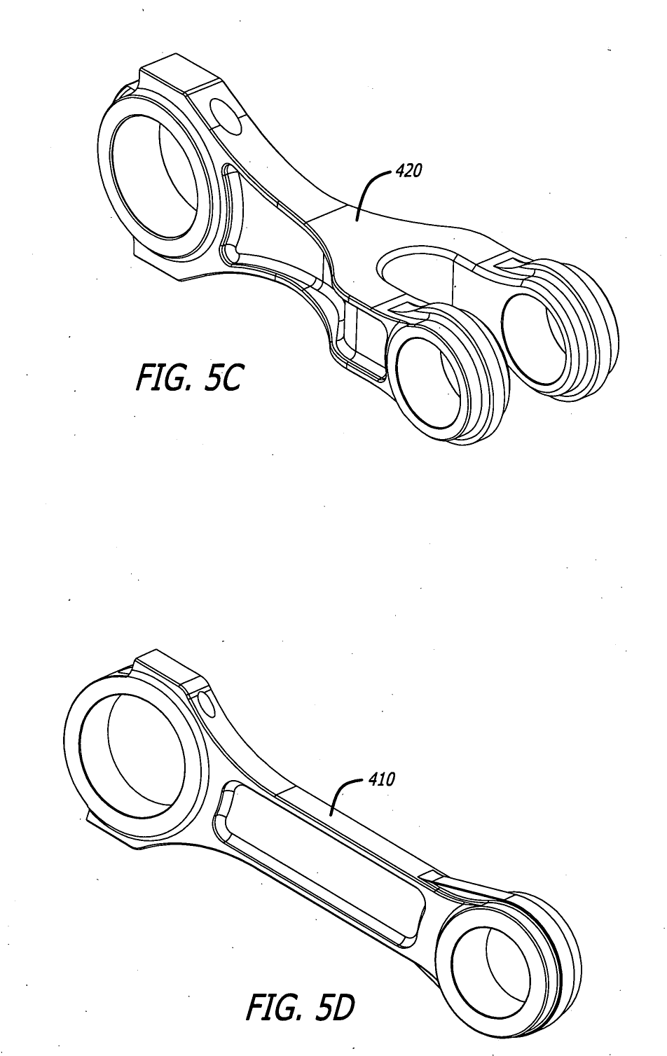

As best seen in FIGS. 3, 5A, and 5B each piston of an opposed pair of pistons 301 and 302 is connected to a single crankpin 451 by a respective rocker arm assembly including a vertically-disposed rocker arm and at least one connecting rod. Each of the rocker arms 430 and 431 has upper and lower ends and a pivot point therebetween where it is pivoted to the frame 110. For an exhaust piston 301, each connecting rod of a pair of connecting rods 410 (FIG. 5D) is connected at one end to the single crankpin 451, and to the lower end of an exhaust side rocker arm 430 at its opposite end. The exhaust side rocker arm 430 is attached at its upper end through a joint with a pin to a rolling thrust bearing assembly 440. The intake piston 302 is connected to the single crankpin 451 through an intake side rocker arm 431 that is attached at its upper end through a pin to a piston thrust bearing 440. One end of a single connecting rod 420 (FIG. 5C) is sandwiched between ends of the two connecting rods 410 on the crankpin 451. The other end of the connecting rod 420 is coupled to the intake side rocker arm 431 at a point 433 between the upper end and the pivot point of the rocker arm. Thus, the connecting rods are asymmetrically connected to the rocker arms 430 and 431.

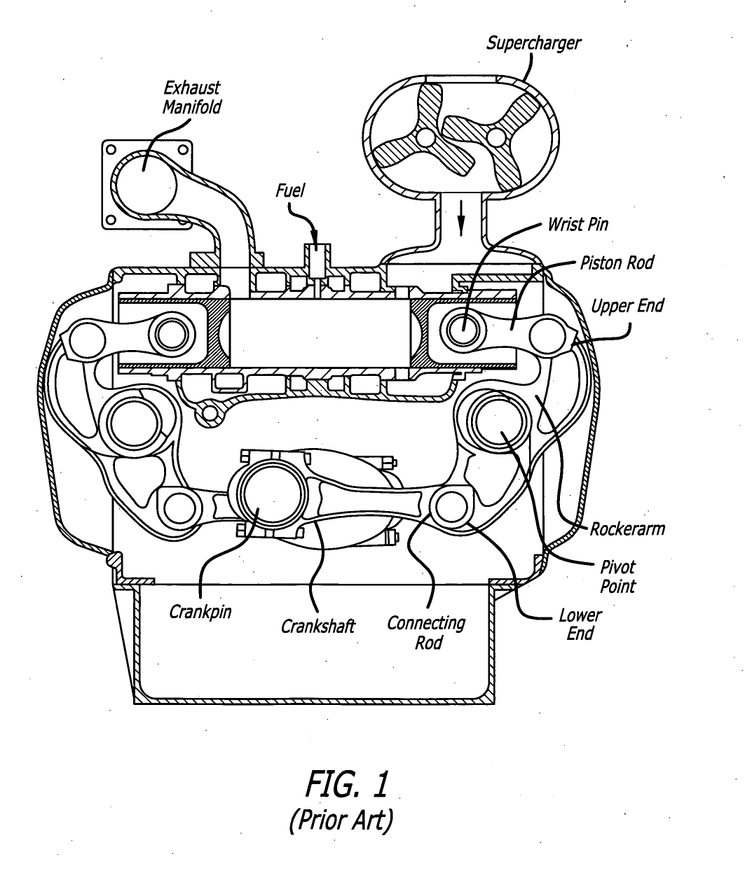

The asymmetrical connection of the connecting rods is one feature which distinguishes the engine of FIGS. 2-4 from the Rootes-Lister engine. As seen in FIG. 1, in the Rootes-Lister engine the connecting rods are symmetrically connected to the rocker arms in that each connecting rod connects to the lower end of a rocker arm, below the rocker arm pivot point. The crankshaft includes two crankpins disposed 180° apart per cylinder. This results in synchronous movement of both pistons which causes the exhaust and intake port to open and close in phase with each other. Phasing of the ports on the Rootes-Lister engine is only achieved by changing the relative angles of the crankpins but the leading phase of the exhaust port opening prevents early closure of the exhaust port.

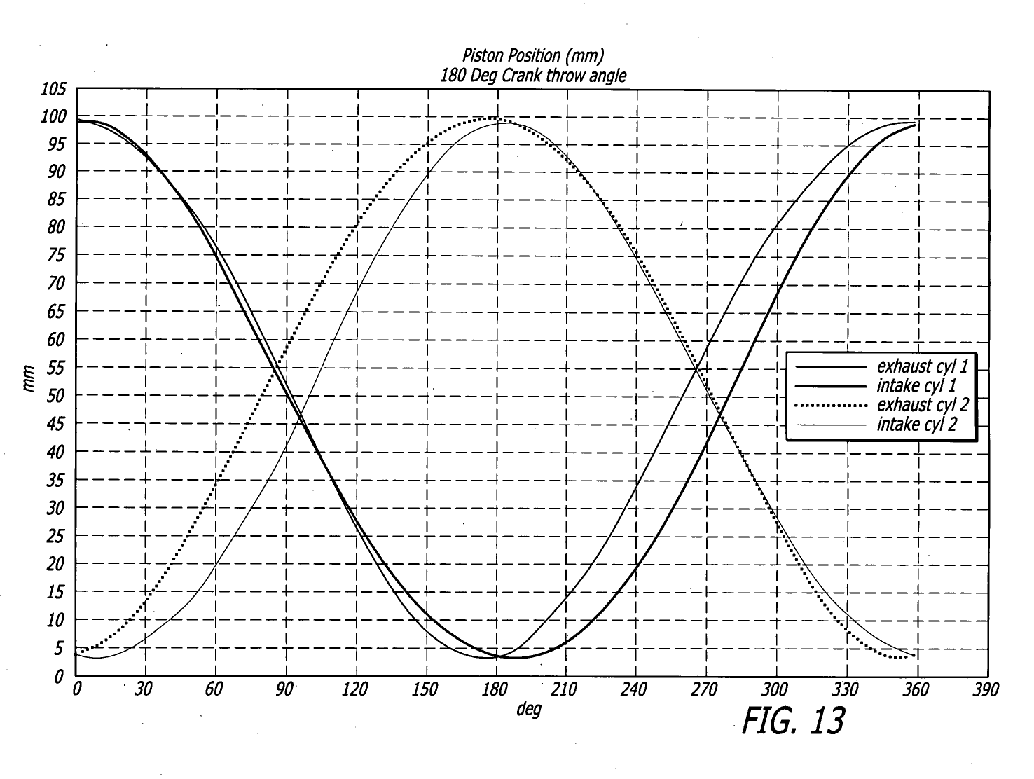

In contrast, in the engine of FIGS. 2-4, at least one exhaust side connecting rod connects to the lower end of the exhaust side rocker arm, below the pivot point, while an intake side connecting rod connects to the intake side rocker arm, above the pivot point, but below the upper end. This asymmetrical connection arrangement results in the pistons being somewhat out of phase with one another so that at a predetermined crank angle after combustion an exhaust cycle will be initiated when the exhaust port opens while the intake port remains closed. Shortly thereafter the intake port will open while the exhaust port remains open, thereby allowing sufficient scavenging time before the exhaust port and intake ports both close to initiate a compression cycle. Both the exhaust and inlet ports close at about the same crank angle. This phasing sequence is graphically represented in FIG. 13.

This port phasing advantage of our engine does not come without a price. Since both connecting rods of the Rootes-Lister engine are attached at the lower ends of their respective rocker arms, all forces acting upon the crankshaft main bearings tend to cancel each other. That is to say, as the pistons move toward respective BDC (bottom dead center) positions, both rocker arms drive their connecting rods toward the crankshaft, creating a torque but exerting equal and opposite forces on the crankshaft main bearings. As the pistons move toward respective TDC (top dead center) positions during the compression cycle, the lower ends of the rocker arms move away from the crankshaft so that all forces acting upon the connecting rods are moving away from the crankshaft. This tends to balance the forces acting upon the crankshaft main bearings during the full cycle.

In some instances, the asymmetrical connection of the connecting rods to the rocker arms does not produce a balance of forces acting upon the crankshaft of the subject engine. When the exhaust side connecting rods, attached to the lower end of the exhaust side rocker arm, are being driven toward the crankshaft as the pistons approach BDC, the intake connecting rod attached between the pivot point and upper end of the intake side rocker arm experiences forces away from the crankshaft. In the two cylinder version of the engine, as one pair of opposed pistons moves toward TDC exerting forces on the crankshaft in one direction, the other pair of opposed pistons in the second cylinder moves toward BDC, exerting forces on the crankshaft in the opposite direction. These two forces can be compensated for if the engine needs to be balanced. Thus, optionally, counterweights 432, shown in FIG. 3, can be added to the lower ends of the intake side rocker arms.

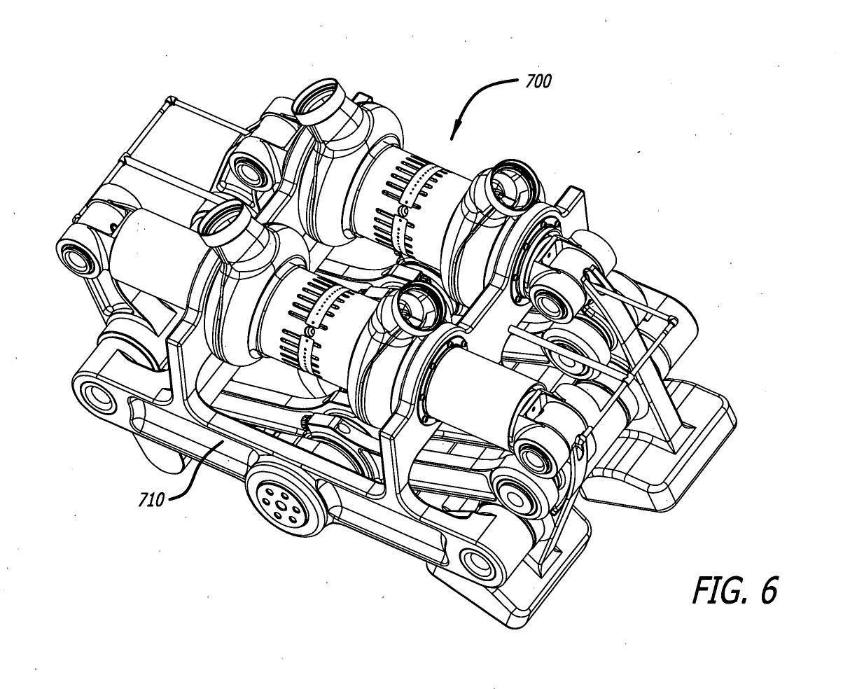

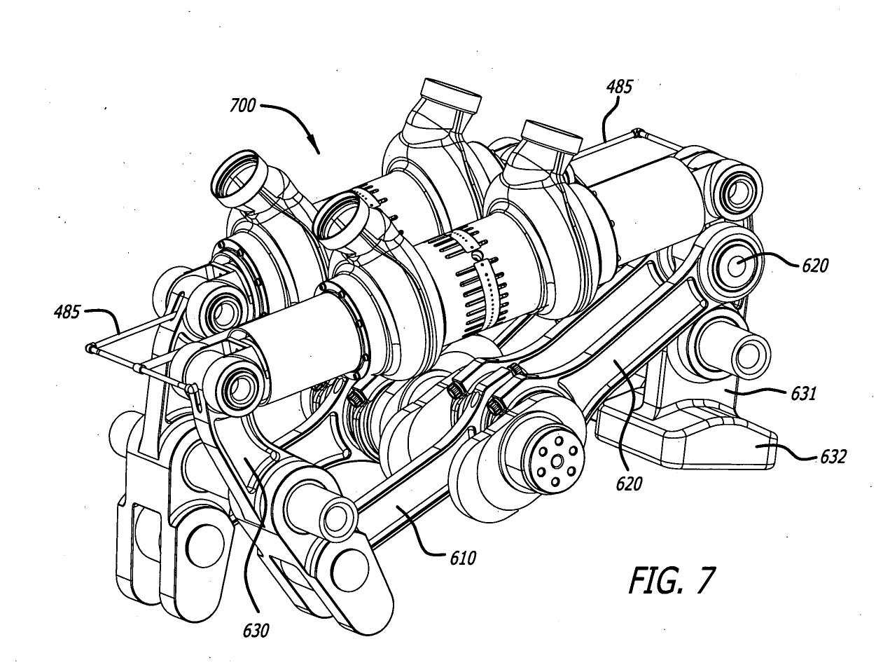

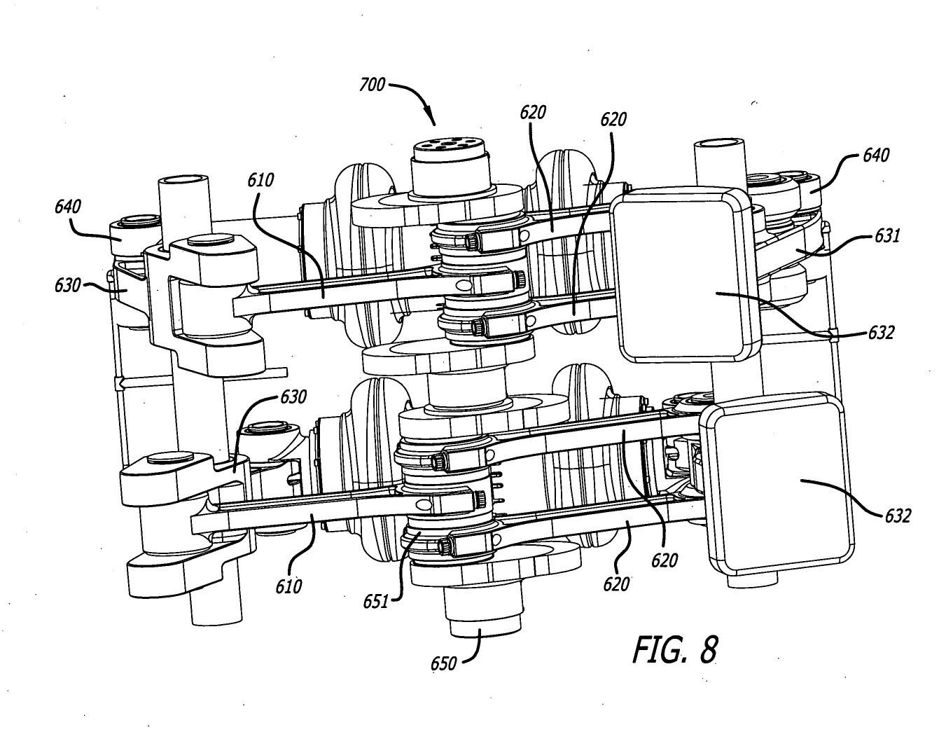

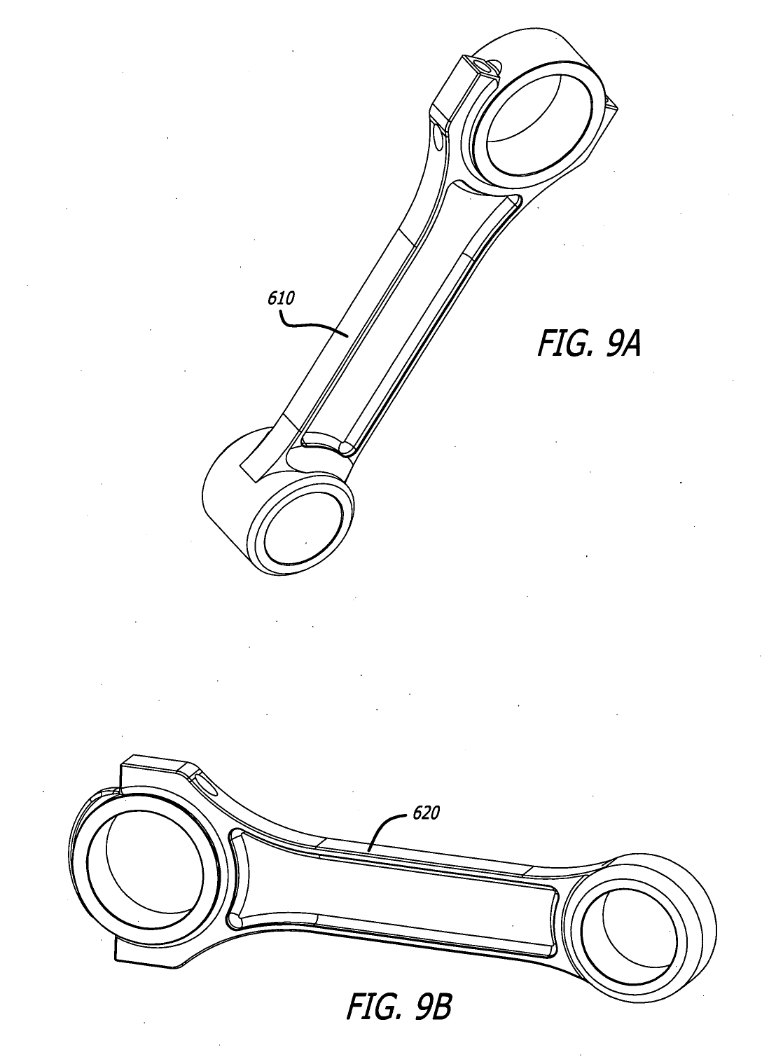

Referring now to FIGS. 6-8 an opposed-piston engine 700 corresponding in most respects to the engine 100 of FIGS. 2-4 utilizes an alternate connecting rod embodiment. The engine 700 has a frame 710 and connecting rods as per FIGS. 7 and 8. As best seen on FIG. 8, a single connecting rod 610 (FIG. 9A) connects the single crankpin to the exhaust side rocker arm 630 and a pair of connecting rods 620 (FIG. 9B) connects the same crankpin to the intake side rocker arm 631. In FIGS. 8, 9A, and 9B the exhaust side connecting rod 610 is attached to the exhaust rocker arm 630 at the same position as counterpart connecting rods 410 on the engine 100 previously described. Each exhaust side rocker arm 630 is attached at its upper end through a joint with a pin to a rolling thrust bearing assembly 640 mounted in an exhaust side piston. Each intake side rocker arm 631 is attached at its upper end through a joint with a pin to a rolling thrust bearing assembly 640 mounted in an intake side piston.

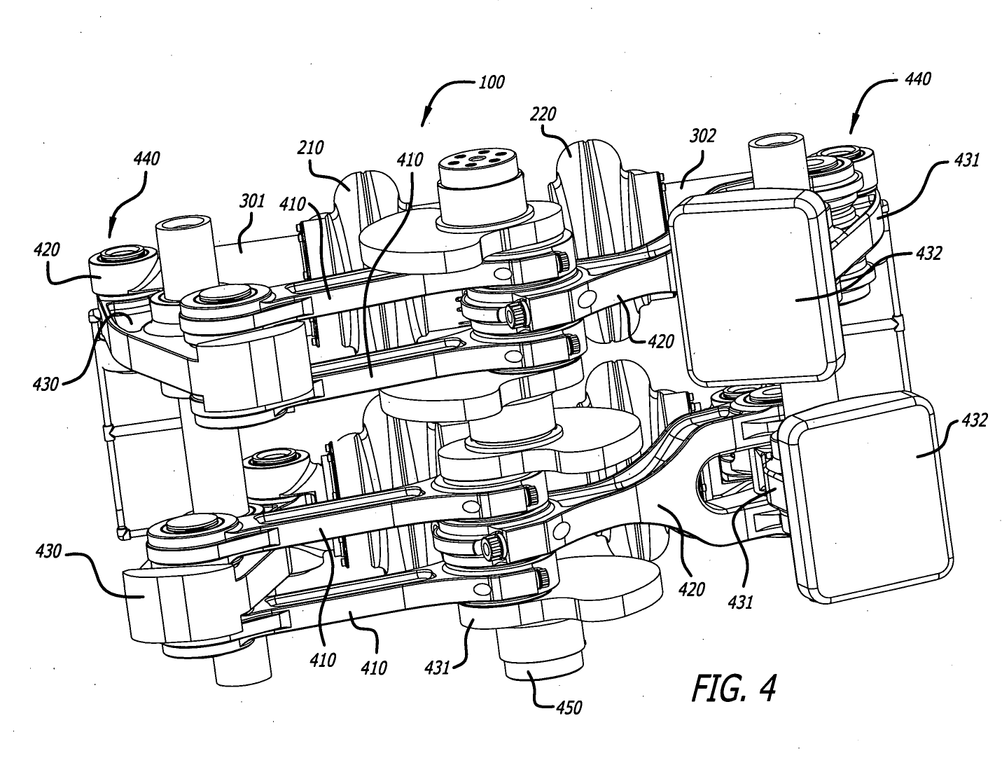

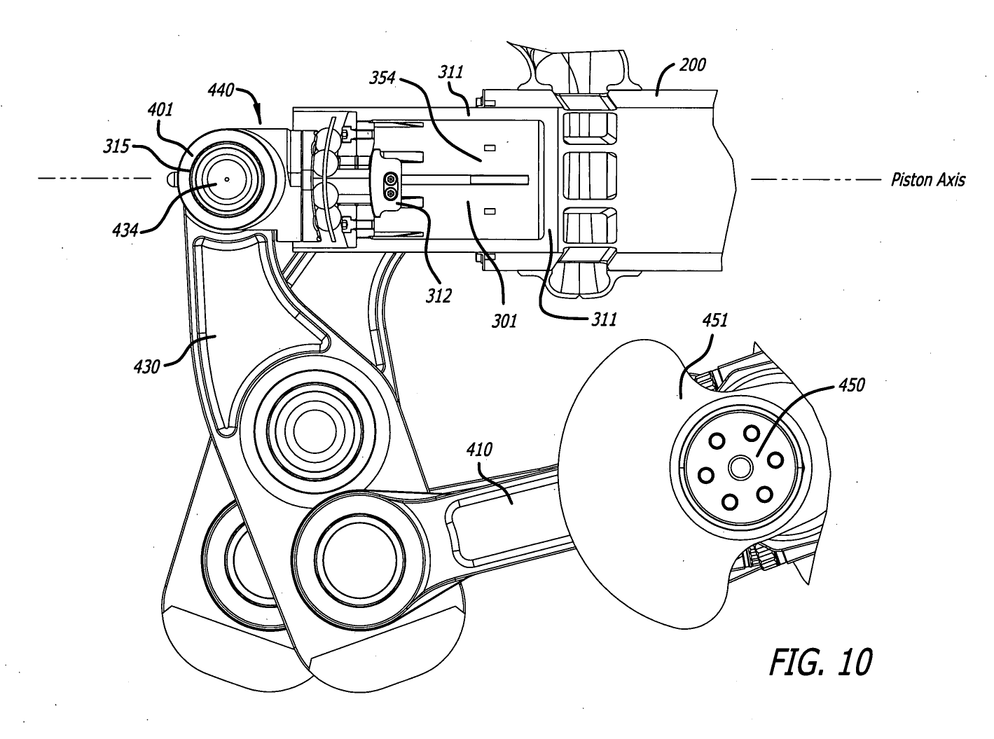

The rolling thrust bearing assemblies 440 & 640 seen in FIGS. 4 and 8 are identical in all respects, as to both the engines 100 and 700 and the exhaust and intake pistons. Therefore references made to elements of the thrust bearing assembly 440 mounted to the exhaust piston 301 apply equally to all of the thrust bearing assemblies used in this engine. As per FIG. 10, a piston rolling thrust bearing assembly 440 (hereinafter, “rolling thrust bearing”) is located remotely from the piston crown 311; it represents a “virtual wrist pin” whose axis of rotation 354 is located within the piston skirt 312, near the back surface of the crown 311. The connecting rod 410 is attached to the crankshaft 450 at one end and to the exhaust side rocker arm 430 at the opposite end. The upper end 434 of the rocker arm 430 is coupled via a pin 315 to a yoke 441 of the piston rolling thrust bearing 440. The piston rolling thrust bearing 440 is secured to the piston 301 by being threaded onto the skirt 312 of the piston 301.

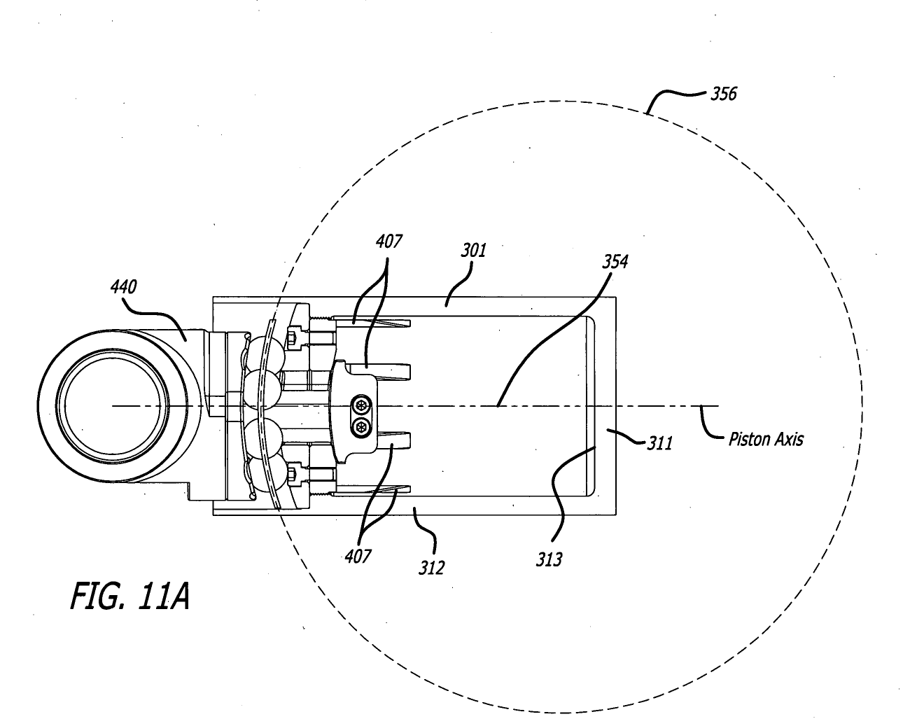

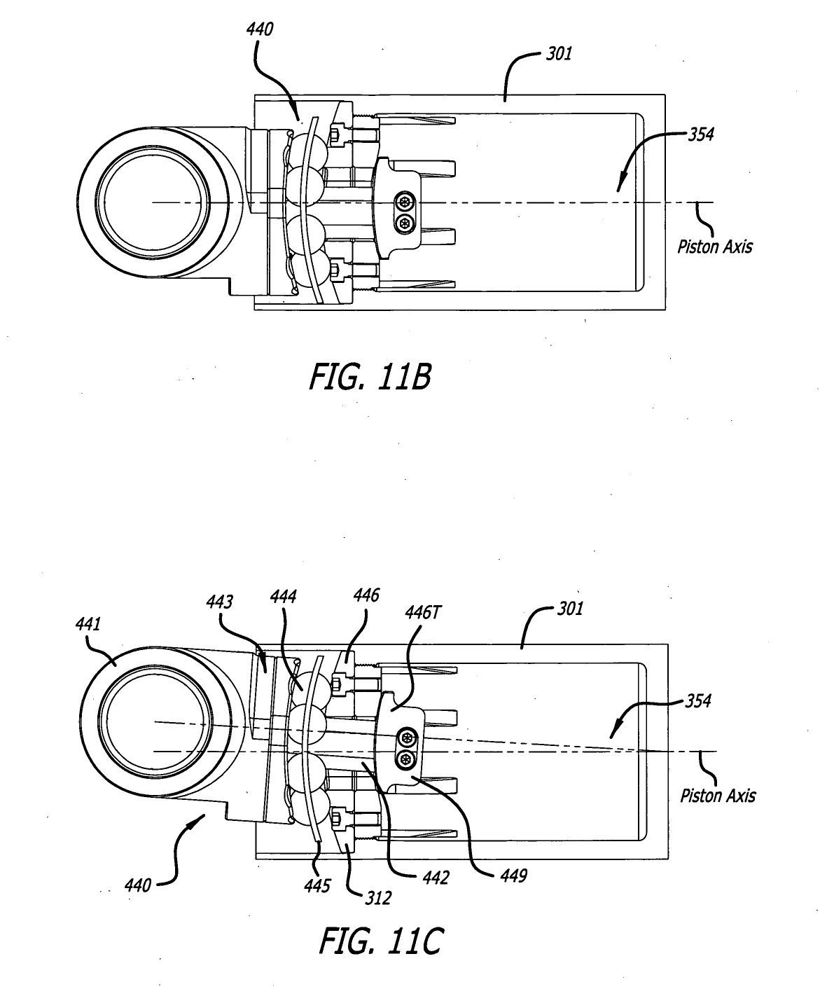

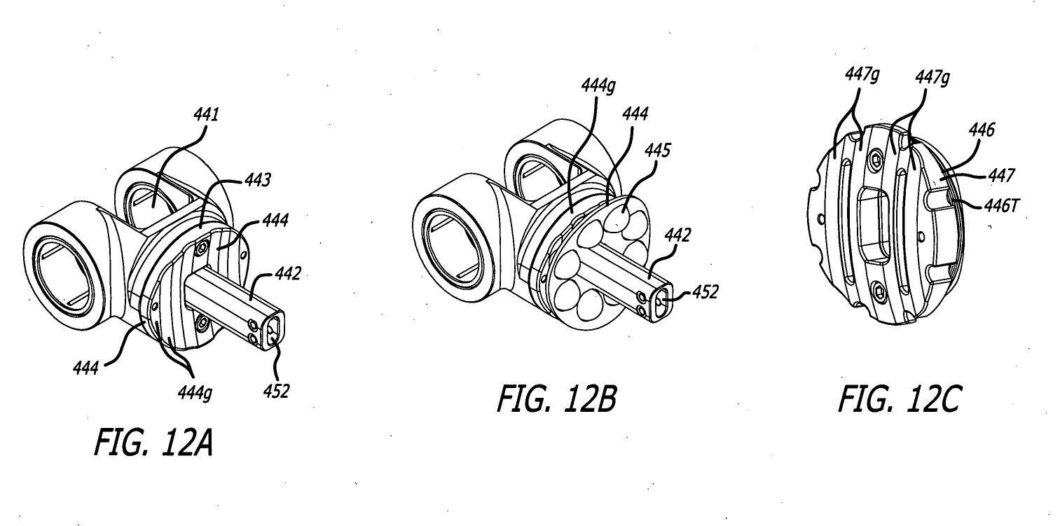

The conventional wrist pin bearing of four-stroke engines is typically a plain bearing that relies on hydrodynamic and squeeze film effects to prevent metal-to-metal contact. In two-stroke engines, the bearing interface is often under a unidirectional load that does not support entrainment of lubrication oil into the interface to supply this separation. Therefore two-stroke engines typically use roller or needle bearings that do not require unloading for their operation. But these bearings are difficult to size small enough to fit within the piston and cylinder while still carrying the peak loads of such applications as internal combustion compression-ignition engines where 200 bar combustion pressures are not uncommon. By relocating the bearing interlace far away from the wrist pin axis, even outside the piston skirt and cylinder envelope, much larger and more plentiful rolling elements can be applied to the bearing function. But simply moving the wrist pin outside the skirt would radically change the skirt loading such that it would appear as a torque on the piston with the skirt edges supporting the loads rather than the skirt surfaces. By using a bearing sector whose rollers and race surfaces reside remotely from the piston crown while still locating a virtual axis of rotation of the bearing near the back surface of the crown, the kinematics of the conventional wrist pin can be preserved while gaining a degree of freedom in using larger bearing elements for handling higher loads. FIG. 11A is a schematic representation of a “virtual bearing” assembly 350 used to illustrate the piston rolling thrust bearing 440. The virtual bearing assembly occupies an arcuate sector 352 of a bearing very much larger than would fit within the piston 301. It should be clear from this figure that the axis of rotation 354 of the virtual bearing wrist pin 356 is at a location very near the back surface 313 of the crown 311 of the piston, inside the piston skirt 312.

As per FIG. 11B, when the piston 301 passes through TDC (near where combustion forces are at a maximum) and BDC (near where inertial forces are at a maximum), the rolling thrust bearing 440 is in straight alignment, (rotated 0°), with reference to the axis of the piston (which perpendicularly intersects the virtual axis of rotation of the “virtual wrist pin”). As per FIG. 11C, when the piston 301 moves from TDC or BDC the rocker arm 430 urges the thrust bearing 440 to pivot from the 0° centered position towards a displaced angle. In this regard, the yoke 441, an elongated bearing retainer mount 442, a first bearing plate 443 with a concave face 444, a curved rolling ball assembly 445 with roller balls, and a retainer bearing 449 all rotate; however, a second bearing plate 446 with a backing plate 446T, secured to the piston skirt 312, remains stationary. Therefore, with reference to FIG. 10, side forces that otherwise would be imparted directly to the piston skirt by movement of the upper end of a rocker arm are directed to the axis 354 of the virtual wrist pin bearing by the moving parts of the rolling thrust bearing 440.

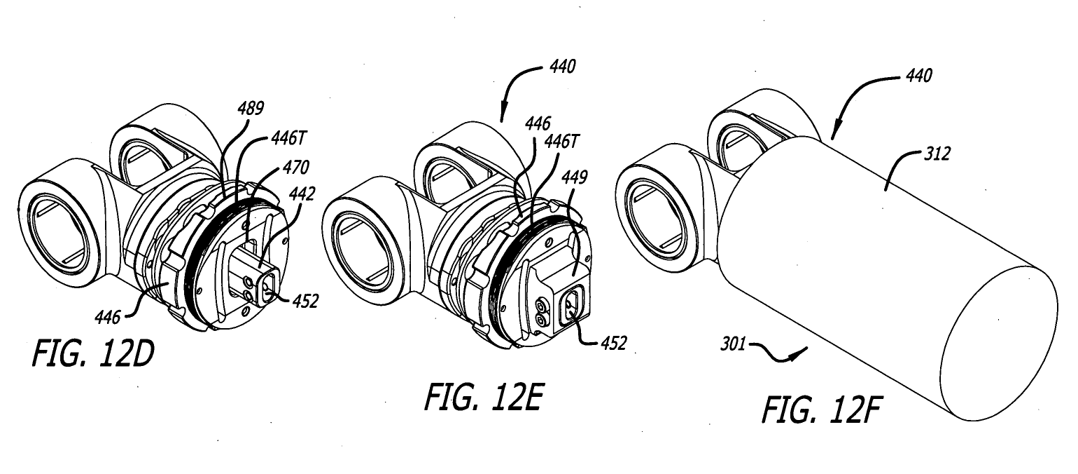

Referring now to FIGS. 12A-12F, the assembly of the thrust bearing assembly 440 is detailed. In FIG. 12A, the elongate bearing retainer mount 442 is formed on or secured to a back plate of the yoke 441. The first bearing plate 443 has a linearly-grooved concave face 444, and is received on the bearing retainer mount 442 and secured to the back plate of the yoke 441 with the concave face 444 facing the end 452 of the retainer mount. The concave face 444 has formed in it a set of elongate spaced ball-race grooves 444g and a central slot through which the retainer mount 442 extends. FIG. 12B, shows the curved rolling ball assembly 445 received on the retainer mount 442, against the concave face 444, with the roller balls oriented in place by the ball-race grooves 444g. As per FIG. 12C, the second bearing plate 446 has a convex face 447 oriented to oppose the concave face 444 of the first bearing plate 443. The concave face 447 has formed in it a set of elongate spaced ball-race grooves 447g and a central slot through which the retainer mount 442 extends. The backing plate 446T is secured to a flat outer surface of the second bearing plate 446. As per FIG. 12D, the second bearing plate 446, with the backing plate 446T secured thereto, is received on the elongate bearing retainer mount 442. The first and second bearing plates 443 and 446 are mutually oriented with the sets of ball-race grooves in the concave and convex faces 444 and 447 in opposing alignment, and the backing plate 446T facing the end 452 of the retainer mount 442. The opposed sets of ball-race grooves constrain the rolling balls for rolling movement in an arc centered on the axis of the piston to which the rolling thrust bearing assembly is mounted. As per FIG. 12E, the piston rolling thrust bearing assembly 440 is held together by a hydrodynamic retainer bearing 449 which is secured to the end 452 of the elongate bearing retainer mount, for example, by screws. The hydrodynamic retainer bearing 449 holds the piston rolling thrust bearing assembly 440 together under reverse inertial load to keep the rolling balls of the rolling ball assembly 445 loaded. A curved surface 470 (best seen in FIG. 12D) formed in the outer face of the backing plate 446T conforms to the bearing surface of the retainer bearing 449, allowing the retainer bearing to slide against the backing plate 446T. As per FIG. 12F, when assembled as illustrated in FIG. 12E, the rolling thrust bearing assembly 440 is secured to the piston 301 by engagement of the threaded portion of the backing plate 446T with the inner surface of the piston skirt 312, with the concave face 444 of the first bearing plate 443 facing toward the interior of the skirt. Although the backing plate 446T is configured as a disc, this bearing seating construction is not meant to be limiting. In another bearing seating construction, the seating element can be configured as a truncated cone with a wide end attached to the outer face of the bearing plate 446 and a narrow end threaded on a post fixed to the back surface of the piston crown.

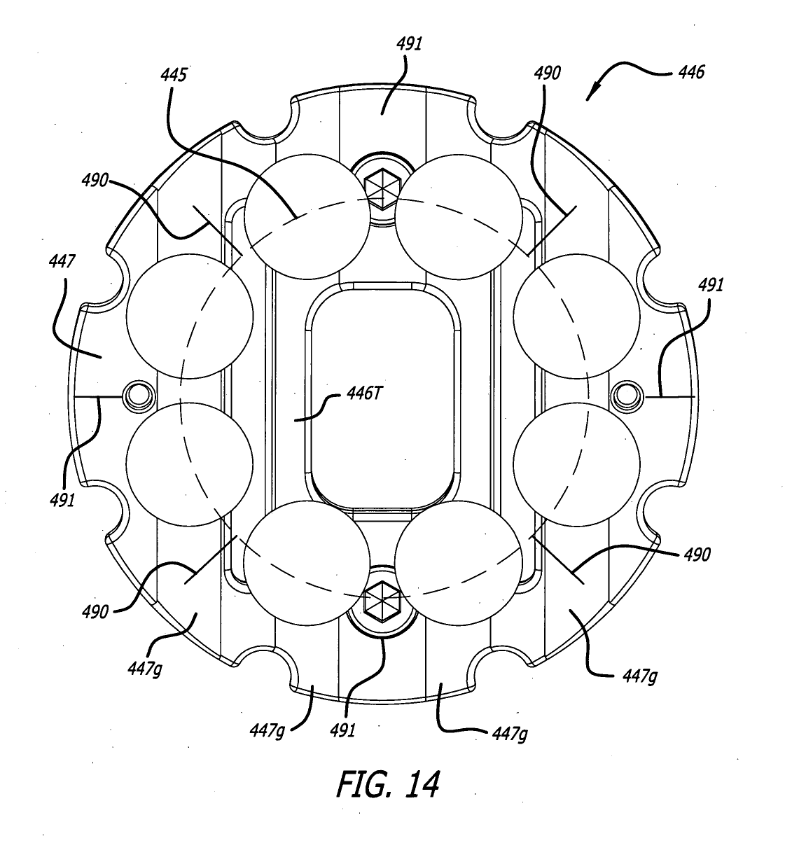

FIG. 14 shows details not seen in FIG. 12C of a preferred construction of the second bearing plate 446. In FIG. 14 roller balls of the rolling ball assembly 445 are engaged in the set of elongate linear ball-race grooves 447g formed in the concave face 447 of the second bearing plate 446. Standard manufacturing processes introduce tolerances in the dimensions of the roller balls, the grooves, and the second bearing plate that can cause loss of contact between roller balls and grooves due to uneven loading of the roller balls. Accordingly, elongate linear slits 490 and 491 through the second bearing plate 446 are provided in interleaved radial patterns in order to permit to bearing plate to flex so as to ensure that all of the roller balls remain in contact with the grooves. The slits 490 extend outwardly from a central opening of the bearing plate 446 toward the circumferential periphery of the bearing plate 446, at least partly across outer grooves. The slits 491 extend inwardly from the circumferential periphery of the bearing plate 446. The interleaved patterns of slits define zones of the bearing plate 446 that can flex independently of each other in response to pressure of the roller balls. In order to accommodate flexion of the bearing plate zones, a shallow depression can be formed in the surface of the backing plate 446T that faces the bearing plate 446.

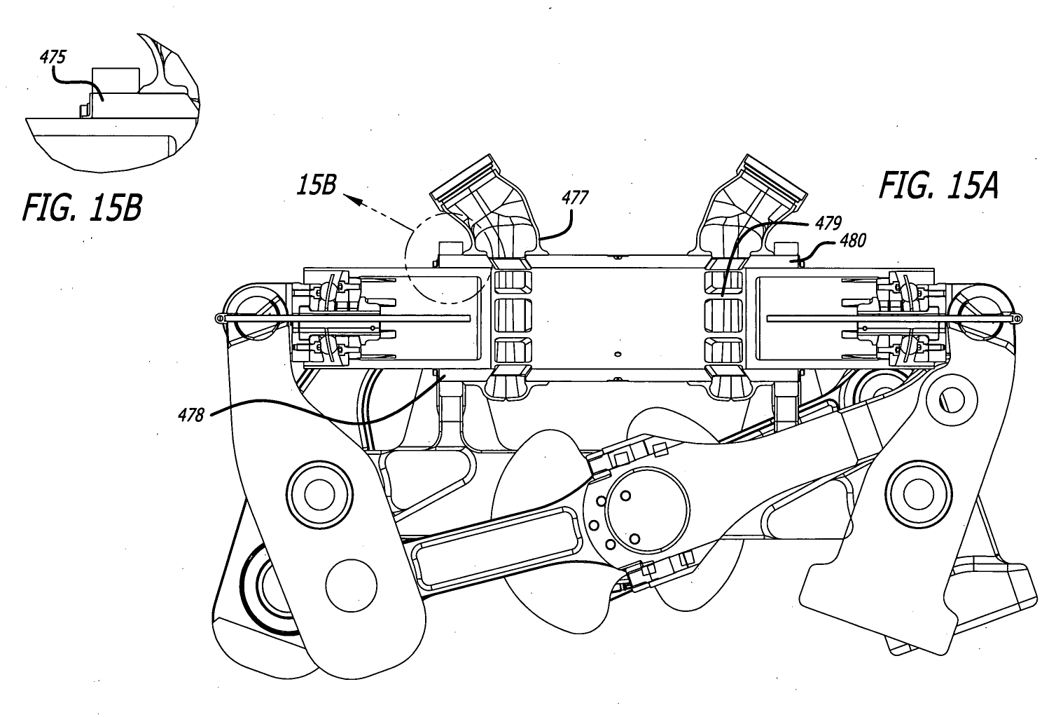

Additional optional details of the engine of FIGS. 2-4 are seen in FIG. 15. An oil wiper seal 475 is secured to the outside rim at each end of each cylinder. Each oil wiper seal is an annular device with an inner rim in sealing contact with the external surface of a piston. As the piston travels between TDC and BDC, the oil wiper seal 475 wipes excess lubricant from the skirt surface. Each cylinder has exhaust and intake ports 477 and 479 formed near respective ends 478 and 480. Each port is constituted of an annular sequence of port openings separated by bridges. Each exhaust and intake port opening 477, 480 may have a ramped side in order to induce swirl in each charge of air entering the cylinder. In addition, each ramped side is angled with respect to the longitudinal axis of the cylinder. Further, the angles of the ramped sides in each port are inclined in the direction of the nearest end of the cylinder. In this regard, the ramps in the openings of the exhaust port 477 are inclined toward the exhaust end 478 of the cylinder while the openings of the intake port 479 are inclined toward the intake end 480. Preferably, but not necessarily, the ramps are angled at 45° in order to enhance the discharge coefficient of gasses entering and leaving the cylinders through the ports.

Finally, presume transport of liquid coolant (which may be engine lubricant, for example) into the piston by way of a manifold jet (485 in FIG. 7) that extends through channels in the upper end of a rocker arm and the elongated retainer mount (442 in FIG. 12A). The liquid coolant is enabled to flow out of the interior of the piston by way of grooves (487 in FIG. 11A) on the inner surface of the piston skirt and notches (489 in FIG. 12D) in the outer edge of the second bearing plate 446.

The scope of patent protection afforded the novel constructions and methods described and illustrated herein may suitably be practiced in the absence of any element or step which is not specifically disclosed in the specification, illustrated in the drawings, and/or exemplified in the embodiments of this application. Moreover, although the invention has been described with reference to preferred embodiments, it should be understood that various modifications can be made without departing from the spirit of the invention. Accordingly, the invention is limited only by the following claims.

1. An internal combustion engine with a piston coupled by a rocker arm assembly to a crankshaft and including a thrust bearing constituted of a pair of bearing plates with opposed complementarily curved faces and a curved roller ball assembly positioned between the curved faces to support relative movement between the bearing plates, in which the thrust bearing is mounted to the open end of the skirt of the piston with the curved face of the first bearing plate facing the interior of the skirt and in which a rear side of the thrust bearing is pivoted to the rocker arm assembly.

2. The internal combustion engine of claim 1, in which the first bearing plate is rotatably coupled to the second bearing plate and the second bearing plate is secured to the skirt and centered on a piston axis.

3. The internal combustion engine of claim 2, in which the curved rolling ball assembly is constrained to roll in an arc transverse to the piston axis by opposing sets of linear ball-race grooves in the opposed curved faces of the first and second bearing plates.

4. The internal combustion engine of claim 3, in which the pair of bearing plates and the curved roller ball assembly are supported on an elongated bearing retainer mount and retained on the elongated bearing retainer mount by a retainer bearing.

5. The internal combustion engine of claim 1, in which the rocker arm assembly includes a rocker arm pivoted to an engine support member at a pivot point between upper and a lower ends and a connecting rod coupled at one end to the rocker arm and at another end to the crankshaft.

6. The internal combustion engine of claim 1, in which the rocker arm assembly includes a rocker arm and a connecting rod, the rocker arm having upper and lower ends and a pivot point at the lower end where the rocker arm is pivoted to an engine support member, and the connecting rod having a first end coupled to the rocker arm between the pivot point and the upper end of the rocker arm and a second end coupled to the crankshaft.

7. An opposed-piston engine with a single crankshaft having at least one crankpin, comprising:
a first rocker arm with upper and lower ends and pivoted to a support member on a pivot point between the upper and lower ends, and a first opposed piston coupled to the upper end of the first rocker arm, one end of a first connecting rod coupled to the at least one crankpin and the other end of the first connecting rod coupled to the lower end of the first rocker arm; and,
a second rocker arm with upper and lower ends and pivoted to a support member on a pivot point between the upper and lower ends, and a second opposed piston coupled to the upper end, one end of a second connecting rod coupled to the at least one crankpin, and the other end of the second connecting rod coupled to the second rocker arm between the pivot point and upper end of the second rocker arm.

8. The opposed-piston engine of claim 7, in which the upper end of the first rocker arm is coupled to the first piston by a first thrust bearing and the upper end of the second rocker arm is coupled to the second piston by a second thrust bearing, and each thrust bearing is constituted of a pair of bearing plates with opposed, complementarily curved faces and a curved roller ball assembly positioned between the opposed faces to support relative movement between the bearing plates, the thrust bearing is mounted to the open end of a piston skirt with the curved face of the first bearing plate facing the interior of the skirt, and a yoke of the thrust bearing is pivoted to the rocker arm assembly.

9. The opposed-piston engine of claim 8, in which the first piston is an exhaust piston and the second piston is an intake piston.

10. The opposed-piston engine of claim 8, in which a counterweight is mounted on the lower end of the second rocker arm.

11. The opposed-piston engine of claim 7, in which the first piston is an exhaust piston and the second piston is an intake piston.

12. The opposed-piston engine of claim 7, in which a counterweight is mounted on the lower end of the second rocker arm.

13. A connecting linkage in an opposed-piston construction with a first rocker arm having a first end for connecting to a first piston, a second end, and a pivot point between the first and second ends, and a first connecting rod with a first end coupled to a crankpin and a second end coupled to the second end of the first rocker arm, and with a second rocker arm having a first end for connecting to a second piston disposed in opposition to the first piston, a second end, and a pivot point between the first and second ends, and a second connecting rod with a first end coupled to the crankpin and a second end coupled between the pivot point and first end of the second rocker arm.

14. A method of operating an opposed-piston engine including a pair of opposed pistons coupled to the same crankpin by moving exhaust and intake pistons between respective top dead center and bottom dead center positions in response to combustion, constraining relative movement between the exhaust piston and first connecting linkage by arcuate bearing movement of a rolling thrust bearing mounted to the exhaust piston and coupled to the first connecting linkage by a pin, and to a first rocker arm at a point below the pivot point of the first rocker arm, and constraining relative movement between the intake piston and second connecting linkage by arcuate bearing movement of a rolling thrust bearing mounted to the intake piston and coupled to the second connecting linkage by a pin.

15. A method of operating an opposed-piston engine including a pair of opposed pistons coupled to the same crankpin by moving exhaust and intake pistons between respective top dead center and bottom dead center positions in response to combustion, constraining movement of the exhaust piston by movement of a connecting rod connected to the crankpin and to a first rocker arm at a point below the pivot point of the first rocker arm, and constraining movement of the intake piston by movement of a connecting rod connected to the crankpin and to a second rocker arm at a point above the pivot point of the second rocker arm.
